(19) United States
(12) Patent Application Publication
(10) Pub. No.: US 2007/0147837 A1
(43) Pub. Date: Jun. 28, 2007

(54) Method of increasing number of subscribers using time division duplexing technology in wavelength division multiplexing/Ethernet passive optical network system

(76) Inventors: Jeong Ju Yoo, Daejeon-city (KR); Byoung Whi Kim, Daejeon-city (KR); Bokrae Jung, Daejeon-city (KR); Jaegwan Kim, Daejeon-city (KR); Namuk Kim, Daejeon-city (KR); Minho Kang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/634,507

(22) Filed: Dec. 6, 2006

(30) Foreign Application Priority Data
Dec. 7, 2005 (KR) 10-2005-0118954
Sep. 6, 2006 (KR) 10-2006-0085886

(51) Int. Cl. H04J 14/00

(52) U.S. Cl. 398/72

(57) ABSTRACT

Provided is a method of increasing the number of subscribers using a time division duplexing (TDD) technology in a wavelength division multiplexing (WDM)/Ethernet passive optical network (WE-PON) system, and more particularly, a method of increasing the number of subscribers admissible per wavelength using a TDD technology. In an existing WE-PON, due to an amplitude squeezing effect (ASE) in an optical network terminal (ONT) and an optical output power restriction in an optical line terminal (OLT), there is a disadvantage in that 4 or more subscribers cannot be simultaneously accommodated per wavelength. However, the present invention enables accommodation of a maximum of 16 subscribers per wavelength by applying a TDD technology to a medium access control (MAC) protocol. Point-to-multipoint services can be provided without the need of an additional header for classifying upstream and downstream window sizes in a downstream bandwidth used in an existing WDM-PON loopback technique using dynamic band allocation (DBA) applied to a conventional E-PON MAC protocol and scheduling algorithm. In addition, a DBA and threshold adjustment mechanism are provided to compensate for a downstream bandwidth decrease caused by application of the TDD technology.

### CROSS-REFERENCE TO RELATED PATENT APPLICATIONS

This application claims the benefit of Korean Patent Application No. 10-2005-0118954, filed on Dec. 7, 2005 Korean Patent Application No. 10-2006-0085886, filed on Sep. 6, 2006, in the Korean Intellectual Property Office, the disclosures of which are incorporated herein in their entirety by reference.

### BACKGROUND OF THE INVENTION

1. Field of the Invention

The present invention relates to a method of increasing the number of subscribers using a time division duplexing (TDD) technology in a wavelength division multiplexing (WDM)/Ethernet passive optical network (WE-PON) system, and more particularly, to a method of increasing the number of subscribers admissible per wavelength using a TDD technology.

2. Description of the Related Art

As computers and the Internet have become widespread, users' demands for large-capacity multimedia services such as voice, data or video have also increased. Accordingly, Internet service providers (ISP) which are responsible for subscriber services have endeavored to provide efficient services as countermeasures to transmission speed restrictions per subscriber, flowing IP provision, and excessive access restrictions, so as to accept as many subscribers' demands as possible.

However, these efforts are not nearly enough to satisfy demands for broadband services that progressively increase.

Currently, bandwidth problems with metro networks and backbone networks have been solved to some degree by means of wavelength division multiplexing (WDM) technology.

However, a relative bandwidth shortage phenomenon in a subscriber network in which several transmission media and protocols exist together, emerges as an issue between ISPs.

The most highlighted technology as a solution to this problem is a fiber to the home (FTTH)-based passive optical network (PON) which has been developed in domestically and overseas.

PON is largely classified into time division multiplexing (TDM)-PON and WDM-PON according to channel multiplexing methods.

Ethernet-PON (E-PON) which is currently a representative TDM-PON, allows ultra-speed Internet services at low cost while accepting an existing Ethernet frame.

E-PON currently provides both upstream/downstream 1 Gbps bandwidth. However, the space is still insufficient to satisfy subscribers' demands for prosperous large-capacity multimedia services.

Meanwhile, unlike E-PON in which several subscribers share one wavelength in a time division manner, a WDM-PON technology which provides a sufficient bandwidth of 1 Gbps per maximum subscriber by allocating a dedicated wavelength to each subscriber, has been proposed, commercially used and standardized.

The WDM-PON technology provides a sufficient bandwidth to a subscriber and simultaneously guarantees the security and transparency of a protocol through a logical point-to-point connection between an optical line terminal (OLT) and an optical network terminal (ONT).

However, on the other hand, it is not reasonable to completely accept the WDM-PON technology in a current stage because of costly equipment and service costs, cannot be ignored.

Thus, a WDM/TDM Hybrid-PON which has advantages and disadvantages of both the TDM-PON and WDM-PON has emerged.

The WDM/TDM Hybrid-PON provides an expansion of an additional bandwidth by providing a plurality of wavelengths and simultaneously accommodates several subscribers per wavelength so that costs per channel required for one subscriber are greatly reduced in order to compensate for disadvantages of WDM-PON.

The present invention is a suggested structure for solving the above described problems. However, it is impossible to provide services to four or more ONT per wavelength without additional facility costs in optical layers and therefore it is difficult to totally accept 128 or more subscribers. This results in a decrease in channel use and efficiency.

### SUMMARY OF THE INVENTION

The present invention provides a method of increasing the number of subscribers admissible per wavelength by applying, to a medium access control (MAC) protocol, a time division duplexing (TDD) technology in which a downstream bandwidth is divided into downstream data traffic and a continuous wave (CW) for upstream traffic in a loopback-type wavelength division multiplexing (WDM)/Ethernet passive optical network (WE-PON) system in which an optical power of a single wavelength optical signal output from an optical line terminal (OLT) is re-received from an optical network terminal (ONT) and is used.

According to an aspect of the present invention, there is provided a method of increasing the number of subscribers using a time division duplexing technology in a wavelength division multiplexing (WDM)/Ethernet passive optical network (WE-PON) system, the Ethernet passive optical network system comprising an OLT (optical line terminal) which is located at a central office and converts a downstream Ethernet frame into a plurality of wavelength optical signals and multiplexes the wavelength optical signals, a remote node (RN) which demultiplexes the multiplexed wavelength optical signals and splits each of the demultiplexed wavelength optical signals, and a plurality of ONTs (optical network terminals) at a subscriber terminal which receive a portion of the split optical signals and re-modulate a portion thereof into an RSOA (reflective semiconductor optical amplifier) in order to transmit it to the OLT, the method including: investigating the number of packets stacked on a queue of each ONT and reporting requested bandwidths according to the number of packets to the OLT; calculating a total request bandwidth by adding the requested bandwidths; comparing the total request bandwidth with an available bandwidth of the OLT and allocating grant bandwidths to each ONT; generating a grant subframe by adding the allocated grant bandwidths; and scheduling a data subframe and the grant subframe and generating a downstream Ethernet frame.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a conventional cascade wavelength division multiplexing (WDM)/time division multiplexing (TDM) Hybrid-passive optical network (PON);

FIG. 2 illustrates a structure of a WDM/Ethernet passive optical network (WE-PON) system according to an embodiment of the present invention;

FIG. 3 illustrates an amplitude squeezing effect (ASE) procedure performed in an existing WE-PON optical network terminal (ONT);

FIG. 4 is the item list of an optical device configuration used in an embodiment of the present invention;

FIG. 5 illustrates an output gain curve with respect to a signal input to an existing WE-PON colorless reflective amplifier (CRA);

FIG. 6 illustrates a downstream time division multiplexing (TDM) link configuration and a scheduler operation by applying a time division duplexing (TDD) technique to an embodiment of the present invention; and

FIG. 7 is a flowchart illustrating a dynamic band allocation (DBA) and threshold adjustment mechanism according to an embodiment of the present invention.

### DETAILED DESCRIPTION OF THE INVENTION

The present invention will be described more fully hereinafter with reference to the accompanying drawings in which exemplary embodiments of the invention are shown.

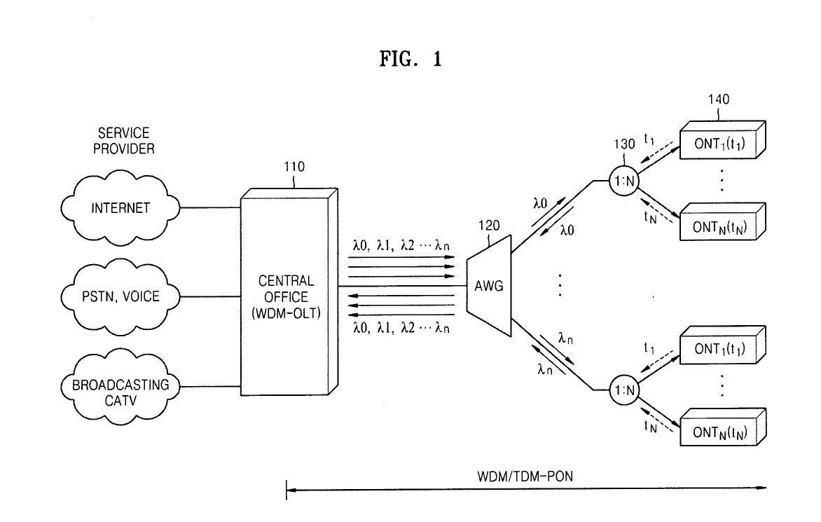

FIG. 1 illustrates a structure of a conventional cascade wavelength division multiplexing (WDM)/time division multiplexing (TDM) Hybrid-passive optical network (PON).

The conventional cascade WDM/TDM Hybrid-PON includes an optical line terminal (OLT) 110 which is located at a central office (CO) connected to the Internet, voice, and video service providers, converts an electrical signal into an optical signal and concentrates the optical signal to a plurality of wavelengths, an arrayed-waveguide grating (AWG) 120 which demultiplexes the concentrated wavelengths and divides them into respective wavelengths, an optical power splitter (OPS) 130 which splits an optical power with respect to one specific divided wavelength between a plurality of optical network terminals (ONTs), and an ONT 140 in a subscriber in which respective optical signals divided between a plurality of branches are finally received and are photoelectrically converted.

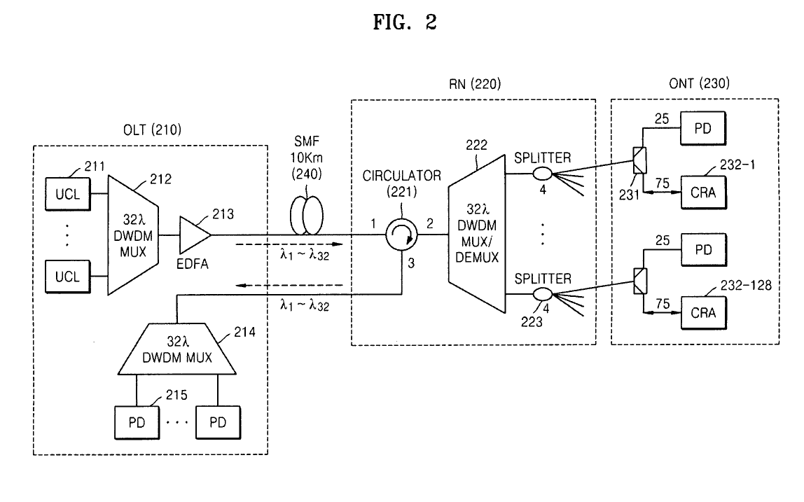

FIG. 2 illustrates a structure of a WDM/Ethernet passive optical network (WE-PON) system according to an embodiment of the present invention.

The OLT 210 includes 32 utility cooled lasers (UCLs) 211 using a single light source, erbium-doped fiber amplifiers (EDFA) 213 which amplify UCL output signals, a high-density 32-wavelength multiplexer 212/demultiplexer 214 for transmission and reception, and a photo detectors (PDs) 215 for detecting received signals.

By adopting a loopback technique by which a downstream optical signal is re-received at a link distance of 10 Km using a 2-core single mode fiber (SMF) 240 between the OLT 210 and a remote node (RN) 220 and is then re-used as an upstream optical signal, an additional light source is not needed in an ONT 230.

The direction of an upstream/downstream signal is classified by the use of ports of a circulator 221 in an RN, and a downstream signal passes through ports 1 and 2 of the circulator 221 and reaches a 32-wavelength demultiplexer 222.

An optical power with respect to 32 divided wavelengths passes through a 4-divergence optical power splitter 223 and is split into four signals whose optical power is uniformly reduced to ¼.

The split optical signal passes through a 25/75 tap coupler 231 located in the ONT 230, and 25% of the optical power is supplied to a photo detector (PD) and 75% of the optical power is supplied to a colorless reflective amplifier (CRA) 232-1, that is, a reflective semiconductor optical amplifier (RSOA), and the optical power is re-modulated into upstream data.

The signal passes through the optical power splitter and the 32-wavelength demultiplexer 222, passes through ports 2 and 3 of the circulator 221 and arrives at a receiver 215 located in the OLT 210.

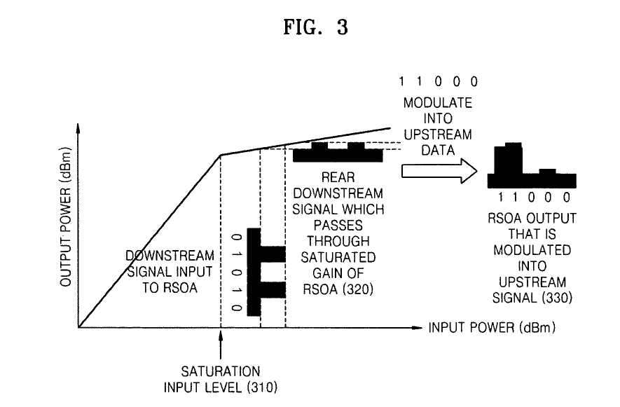

FIG. 3 illustrates an amplitude squeezing effect (ASE) procedure performed in an existing WE-PON ONT.

A downstream modulation signal that descends from a light source of the OLT 210 is amplified by a colorless reflective amplifier (CRA) 232-i of the ONT 230 before upstream data transmission is performed.

The amplitude of a modulated signal input to the CRA 232-i at more than a saturation input level 320 of the CRA 232-i is remarkably reduced compared to the amplitude of the initial input modulated signal, due to an amplification gain characteristic of the CRA 232-i, and is referred to as an amplitude squeezing effect (ASE).

The modulated signal input to the CRA 232-i as a result of the ASE is transformed into a carrier wave having a similar shape to that of a continuous wave (CW) generated in the initial light source of the OLT 210 (320).

By using a loopback technique by which an upstream modulated signal is re-modulated (330) on the transformed CW and upstream-ascends, upstream traffic can be transmitted without an additional light source in the ONT 230.

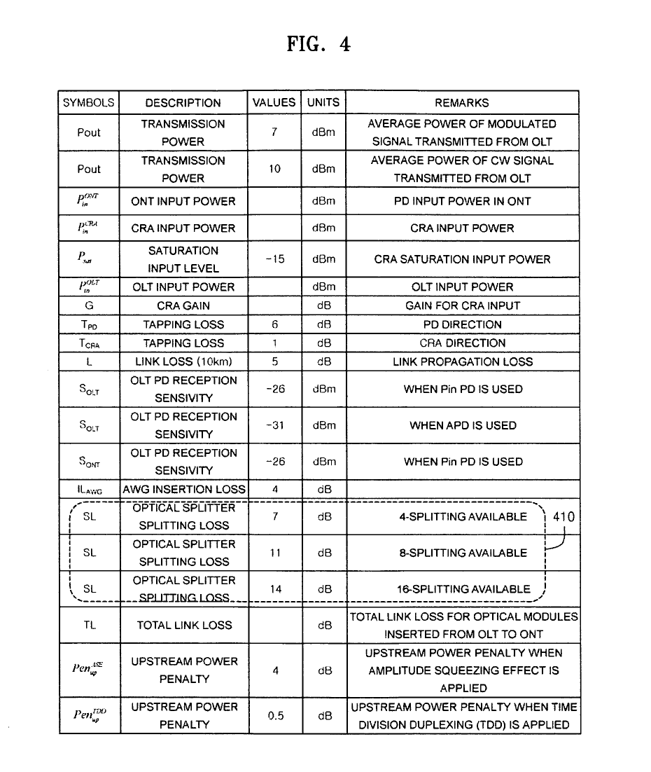

FIG. 4 is the item list of an optical device configuration used in an embodiment of the present invention.

This provides information related to basic optical modules used in the present system so as to obtain a possible branching factor 410 in an optical power splitter when the ASE used in bi-directional transmission is applied to an existing WE-PON and the possible branching factor 410 in an optical power splitter 223 when a time division duplexing (TDD) technique, instead of the ASE, is applied to a medium access control (MAC) protocol.

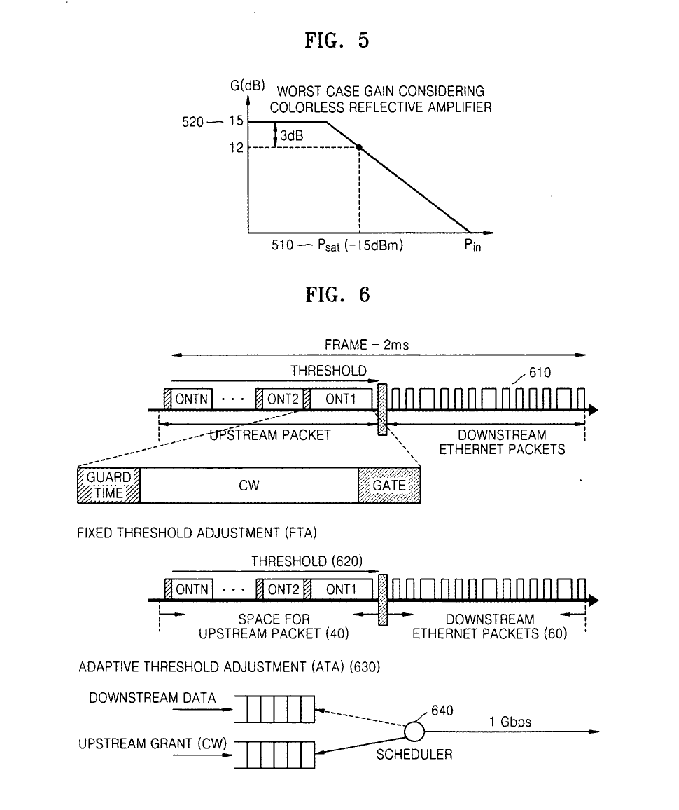

FIG. 5 illustrates an output gain curve with respect to a signal input to an existing WE-PON colorless reflective amplifier (CRA). That is, FIG. 5 illustrates an output gain curve with respect to a CRA input signal used in the following proof.

When minimum splitting losses of an optical power splitter are given according to 4, 8, and 16 splitting ratios, the amount of total link losses with respect to an optical module inserted from the OLT 210 to the ONT 230 can be expressed by Equation 1:
TL(TotalLinkLoss)=IL_{AWG}+L+IL_{AWG}+SL+T_{CRA}=4+5 +4+SL+1=14+SL (1)
where

IL_{AWG} represents an insertion loss in the 32-wavelength multiplexer 212 of OLT,

L represents a link loss generated while passing through a link distance of 10 Km,

IL_{AWG} represents an insertion loss in the demultiplexer 222 in an RN,

SL represents a splitting loss caused by the optical power splitter 223, and

T_{CRA} represents a tapping loss generated in the tap coupler 231 of the ONT 230.

In regard to the optical power generated in the UCL of the OLT 210, the sum of an insertion loss while passing through the 32-wavelength multiplexer 212, a link loss generated while passing through a link distance of 10 Km, an insertion loss while passing through a 32-wavelength demultiplexer 222, a splitting loss caused by an optical power splitter 223, and a tapping loss generated by splitting a portion of an optical power in a PD direction may be regarded as a total link loss.

When loopback bidirectional communication is performed using the ASE in the CRA in the ONT 230 like in the existing WE-PON, the magnitude of a signal input to each receiving terminal should be more than a minimum reception sensitivity of a PD or an avalanche photo diode (APD) used in the ONT 230 and the OLT 210 so that the average optical power of a signal modulated in the OLT 210 can be correctly detected at receiving terminals of the ONT 230 and the OLT 210.

The amount of maximum split losses of the optical power splitter which enables the magnitude of a signal input to each receiving terminal to be more than a minimum reception sensitivity of a PD or an APD used in the ONT 230 and the OLT 210, can be obtained using Equation 2 or 3.

In this case, since upstream modulation is performed in the ONT 230 by re-using a downstream signal by using the ASE, a completely upstream-modulated signal cannot be generated and the ONT 230 suffers an upstream power penalty

$$( {Pen}_{up}^{ASE} ) .$$

In addition, the downstream modulated signal that enters an amplifier in the ONT 230 is regarded as being −15 dBm which is a minimum saturation input level value (510).

Case 1: A splitting loss (SL) of an optical power splitter for bidirectional transmission in an existing WE-PON is given by

$${P}_{IN}^{CRA} = {P}^{OUT} - TL > {P}_{sat} = 7 - 12 - SL > - 15 \\ ∴ SL < 8 ( 4 \text{-} splitting ) \\ \begin{matrix}{P}_{IN}^{OLT} = {P}_{sat} + G - TL - {Pen}_{up}^{ASE} > {S}_{OLT} \\ = - 15 + G ( = 12 ) - 14 - \\ SL - 4 > - 31 ( OLT APD reception sensivity )\end{matrix} \\ ∴ SL < 7 ( 4 \text{-} splitting ) \qquad ( 2 )$$

As a result of Equation 2, it is verified that 4 or more subscribers cannot be accommodated per wavelength in bi-directional transmission of the existing WE-PON.

On the other hand, when a TDD technique is applied to the MAC protocol, instead of the ASE, according to an embodiment of the present invention, the maximum amount of splitting losses of the optical power splitter 223 required so that the average optical power of the signal modulated in the OLT 210 can be easily detected in the receiving terminals of the ONT 230 and the OLT 210, is obtained using Equation 3.

In this case, since modulation is performed on the CW descending from the downstream in the ONT 230 without re-using an upstream signal, the ONT 230 has an upstream power penalty

$$( {Pen}_{up}^{TDD} )$$

that is smaller than

$${Pen}_{up}^{ASE} .$$

In addition, the downstream modulated signal that enters the amplifier in the ONT 230 has a value higher than a minimum saturation input level and thus has a gain of 15 dB (520).

Case 2: A splitting loss (SL) of optical power splitter for bi-directional transmission when TDD according to an embodiment of the present invention is applied

$$\begin{matrix}{P}_{IN}^{ONT} = {P}^{OUT} - TL - {T}_{PD} + {T}_{CRA} > {S}_{ONT} \\ = 10 - 14 - SL - 6 + 1 > - 26\end{matrix} \\ ∴ SL < 17 ( 16 \text{-} splitting ) \\ \begin{matrix}{P}_{IN}^{OLT} = {P}^{OUT} + G - TL - {Pen}_{up}^{TDD} > {S}_{OLT} \\ = 10 - 14 - SL + G ( = 15 ) - 14 - SL - \\ 0.5 > - 31 ( OLT APD reception sensivity )\end{matrix} \\ ∴ SL < 13.75 ( 16 \text{-} splitting ) \qquad ( 3 )$$

FIG. 6 illustrates a downstream time division multiplexing (TDM) link configuration and a scheduler operation by applying a TDD technique to an embodiment of the present invention.

By applying the TDD technique, a downstream bandwidth is classified into an actual downstream data region and a CW burst region for upstream transmission (610).

A downstream frame includes a downstream data region and a CW region for ONT upstream modulation. The maximum of thresholds that indicate a total CW burst size granted in the ONT should always be smaller than a polling cycle.

The CW burst is a granted window size value based on a dynamic band allocation (DBA) policy applied to the OLT related to packet requests stacked on ONT1 to ONTN queues before one polling cycle.

In the TDD technique according to an embodiment of the present invention, since a portion of downstream bandwidth should be sacrificed for upstream traffic, there is a disadvantage in that a maximum bandwidth that can be downstream-transmitted is reduced due to the sacrificed downstream bandwidth.

However, if this loss is taken as the verified result in a protocol layer, a splitting ratio can be expanded in an optical layer from 4 subscribers to 16 subscribers per wavelength so that a system in which a total of 512 subscribers can be accommodated, can be implemented without any additional equipment cost.

A point for classifying upstream/downstream regions within a downstream bandwidth is referred to as threshold (620), and a threshold can be adaptively changed (630) according to traffic circumstances within a setting limit by a scheduler according to upstream traffic circumstances generated in the ONT (640).

The downstream frame structure can provide point-to-multipoint services without the need of an additional header for classifying upstream and downstream window sizes in a downstream bandwidth used in an existing WDM-PON loopback technique using DBA applied to a commonly-used E-PON MAC protocol and a scheduling algorithm.

In a traffic pattern that is asymmetrically burst, such as usual file transmission, when upstream/downstream channels are additionally provided, the rate of using channels may be reduced.

In general, the amount of downstream traffic transmission is larger than the amount of upstream traffic transmission.

In these circumstances, if DBA is applied to an upstream bandwidth (CW burst) and an adaptive threshold adjustment (ATA) algorithm is applied to a scheduler, a downward bandwidth loss caused by applying a TDD technique can be minimized.

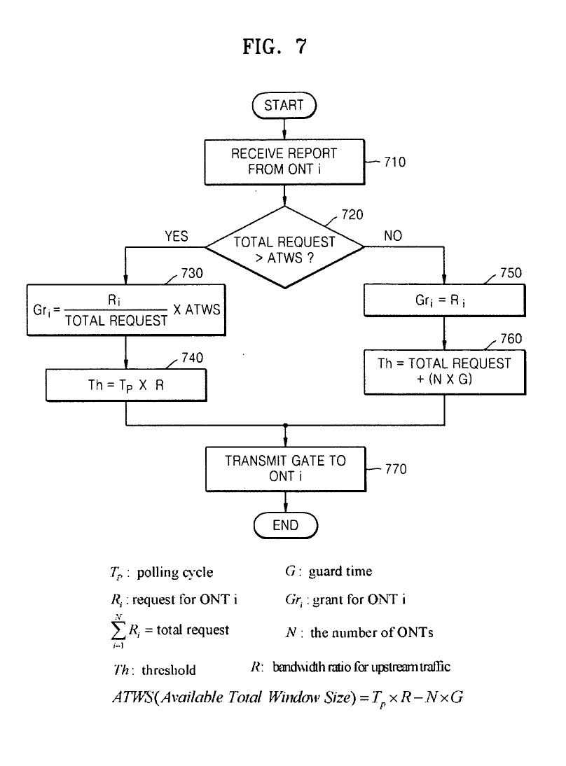

FIG. 7 is a flowchart illustrating a DBA and threshold adjustment mechanism according to an embodiment of the present invention.

The flowchart of FIG. 7 relates to a mechanism related to DBA and an ATA algorithm applied to a MAC protocol used in an embodiment of the present invention.

An ONT i sends a report message to an OLT by investigating the number of packets stacked on its own queue (operation 710).

The OLT collects all the requests for ONT1 to ONTN and then compares the total requests with an available total window size (ATWS) (operation 720).

If the total requests are larger than the ATWS, a GRANT bandwidth for the ONT i is allocated by a relative size of a request for the ONT i with respect to the total requests in the ATWS (operation 730).

Since the sum of requests for total ONT is larger than the ATWS, a threshold can be determined by multiplying a tentatively-set maximum upstream bandwidth ratio by the entire downstream bandwidth (operation 740).

Meanwhile, if the total requests are equal to or smaller than the ATWS, an ONT i is granted by a window size requested by the ONT i (operation 750).

In addition, the threshold is re-adjusted to a value obtained by adding a total guard time for N ONTs to the total requests (operation 760).

A GRANT bandwidth value set in the ONTi based on this DBA mechanism is included in a gate message and is transmitted by a scheduler at an appropriate time (operation 770).

A downstream frame is taken from two queues for upstream and downstream transmission at a front end of an OLT scheduler and includes a technique in which a threshold for an upstream bandwidth is adaptively adjusted according to a request for ONT and a GRANT bandwidth is scheduled at an appropriate time according to a DBA policy within the set threshold.

Preferably, the downstream frame includes specific ATA according to a change in the amount of requests for an ONT based on various traffic circumstances and a DBA procedure related to each ONT.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. (Also, functional programs, codes, and code segments for accomplishing the present invention can be easily construed by programmers skilled in the art to which the present invention pertains.)

As described above, the present invention has an economical effect in which the number of subscribers can be increased without additional cost by applying a TDD technology to a MAC protocol of an existing WE-PON system.

The present invention has an advantage in that a DBA and threshold adjustment mechanism is performed using an OLT scheduler so as to compensate for a downstream bandwidth decrease caused by the application of a TDD technology so that a downstream band loss can be minimized, smooth bidirectional communications can be provided and the efficiency of networks can be maximized.

According to the present invention, an additional header for classifying upstream and downstream window sizes is not needed in a downstream bandwidth used in an existing WDM-PON loopback technique by using the DBA and scheduling algorithm applied to a commonly used E-PON MAC protocol.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A method of increasing the number of subscribers using a time division duplexing technology in a wavelength division multiplexing (WDM)/Ethernet passive optical network (WE-PON) system, the Ethernet passive optical network system comprising an OLT (optical line terminal) which is located at a central office and converts a downstream Ethernet frame into a plurality of wavelength optical signals and multiplexes the wavelength optical signals, a remote node (RN) which demultiplexes the multiplexed wavelength optical signals and splits each of the demultiplexed wavelength optical signals, and a plurality of ONTs (optical network terminals) at a subscriber terminal which receive a portion of the split optical signals and re-modulate a portion thereof into an RSOA (reflective semiconductor optical amplifier) in order to transmit it to the OLT, the method comprising:
investigating the number of packets stacked on a queue of each ONT and reporting requested bandwidths according to the number of packets to the OLT;
calculating a total request bandwidth by adding the requested bandwidths;
comparing the total request bandwidth with an available bandwidth of the OLT and allocating grant bandwidths to each ONT;
generating a grant subframe by adding the allocated grant bandwidths; and
scheduling a data subframe and the grant subframe and generating a downstream Ethernet frame.

2. The method of claim 1, wherein the downstream Ethernet frame is a MAC (medium access control) protocol frame downstream-transmitted to a gate of each ONT from the OLT.

3. The method of claim 1, wherein the grant subframe comprises CW (continuous wave) signals.

4. The method of claim 1, wherein, when the total request bandwidth is larger than the available bandwidth of the OLT, the grant bandwidth allocated to each ONT is obtained by performing a process comprising:
dividing the bandwidth requested in each ONT into the total request bandwidth; and
multiplying the available bandwidth of the OLT by the result of the division.

5. The method of claim 1, wherein, when the total request bandwidth is smaller than the available bandwidth of the OLT, the grant bandwidth allocated to each ONT is equal to the bandwidth requested in each ONT.
